(19) United States
(12) Patent Application Publication
(10) Pub. No.: US 2005/0064576 A1
(43) Pub. Date: Mar. 24, 2005

(54) Methods for remediating materials contaminated with halogenated aromatic compounds

(76) Inventors: Donna E. Fennell, North Brunswick, NJ (US); Max M. Haggblom, New York, NY (US); Stephen H. Zinder, Ithaca, NY (US); Ivonne Nijenhuis, Leipzig (DE)

Correspondence Address: Jane Massey Licata;Licata & Tyrrell P.C., 66 E. Main Street, Marlton, NJ, 08053, US

(21) Appl. No.: 10/828,781

(22) Filed: Apr. 21, 2004

Related U.S. Application Data
(60) Provisional application No. 60/464,348, filed on Apr. 22, 2003.

(51) Int. Cl. C12S 1/00

(52) U.S. Cl. 435/262.5

(57) ABSTRACT

The present invention relates to methods for remediating a material contaminated with a halogenated aromatic compound. Cultures containing Dehalococcoides ethenogenes strain 195 are disclosed which decontaminate halogenated aromatic compounds by removing at least one halogen group from the aromatic compound. The addition of a simple halogenated compound to a contaminated material is also provided for stimulating or supporting the growth of a dehalogenating organism thereby enhancing the bioremediation process of a contaminated material.

This application claims the benefit of priority from U.S. patent application Ser. No. 60/464,348, filed Apr. 22, 2003, which is incorporated herein by reference in its entirety.

This invention was made in the course of research sponsored by the Department of Defense (Grant No. DACA72-01-0-0019). The U.S. government may have certain rights in this invention.

### BACKGROUND OF THE INVENTION

Despite international efforts to control and regulate persistent halogenated organic pollutants, past and on-going releases have resulted in widespread contamination of soils and sediments. The U.S. Environmental Protection Agency (EPA) Toxics Release Inventory database indicates that 150 kilograms of dioxin and dioxin-like substances, 1.13 million kilograms of polychlorinated biphenyls (PCBs), and 16 thousand kilograms of hexachlorobenzene (HCB) were released to the environment from monitored industries in 2001 (http://www.epa.gov/tri/). The total global environmental load of PCBs is estimated at 900 to 1800 million kg (Häggblom and Bossert. in Dehalogenation: Microbial Processes and Environmental Applications, M. H. Häggblom, I. D. Bossert, Eds. (Kluwer Academic, Boston, 2003) Chap. 1). Worldwide mass balances on polychlorinated dibenzo-p-dioxins and dibenzofurans (PCDD/F) are incomplete since these compounds are produced inadvertently during a variety of combustion and chemical synthesis processes. However, one study in 1996 estimated total annual global deposition of PCDD/Fs from the atmosphere to be 13,000 kilograms/year (Brzuzy and Hites (1996) Environ. Sci. Technol. 30:1797-1804). There is an indication that polychlorinated naphthalenes (PCNs), compounds used in similar industrial applications as PCBs, are also ubiquitous environmental contaminants and undergo similar long-range global transport as PCBs and PCDD/Fs (Kannan, et al. (2000) Environ. Sci. Technol. 34:566-572; Kannan, et al. (2001) Environ. Sci. Technol. 35:441-447). The contamination is often present at part per trillion to part per million levels, but growing evidence suggests adverse effects of PCBs and PCDD/Fs on humans and wildlife even at low levels (Agency for Toxic Substances and Disease Registry (ATSDR), Toxicological profile for chlorinated dibenzo-p-dioxins (CDDs), Atlanta, Ga.: U.S. Department of Health and Human Services, Public Health Service, 1998 and 2000). Biomagnification of PCBs and PCDD/Fs in the trophic web increases the risks to humans and decreases the value of fisheries worldwide. The cost of remediating these problems is enormous, so much so that clean up of large areas has not often been attempted. The amount of contaminated aquatic sediments in the United States is estimated to be approximately 1.2 billion cubic yards (U.S. EPA (1998) EPA's Contaminated Sediment Management Strategy. EPA-823-R-98-001). Treatment costs could reach billions or trillions of dollars, depending upon the remedial process (U.S. EPA (1993) Selecting Remediation Techniques for Contaminated Sediment. EPA-823-B93-001).

Advances in technologies to remediate sediments and soils are needed. The use of microorganisms for in situ remediation represents one potential solution. For example, anaerobic bioremediation has been shown to be an effective way to treat the widespread environmental pollutants, the chlorinated ethenes. This bioremedial process results in the reductive dechlorination of tetrachloroethene (PCE), trichloroethene (TCE), dichloroethene (DCE) and vinyl chloride (VC) to the environmentally acceptable end product, ethene (DiStefano, et al. (1991) Appl. Environ. Microbiol. 57:2287-2292; Lendvay, et al. (2003) Environ. Sci. Technol. 37:1422-1431). The organisms most effective at reductive dechlorination use these compounds as electron acceptors for anaerobic respiration (Holliger, et al. in Dehalogenation: Microbial Processes and Environmental Applications, M. H. Häggblom, I. D. Bossert, Eds. (Kluwer Academic, Boston, 2003) Chap. 5). Whereas several organisms can dechlorinate PCE and TCE to DCE, the bacterium Dehalococcoides ethenogenes strain 195 is able to dehalogenate chlorinated ethenes to VC and ethene (Maymó-Gatell, et al. (1997) Science 276:1568-1571) and a new isolate, Dehalococcoides sp. strain BAV1 respires VC to ethene (He, et al. (July 2003) Nature 424:62-65). These organisms represent two of only four described isolates of this group. The presence of Dehalococcoides-like 16S rRNA gene sequences in environments where dehalogenation of the chlorinated ethenes proceeds past DCE indicates that these and closely related organisms have bioremedial significance and that they are widely distributed (Hendrickson, et al. (2002) Appl. Environ. Microbiol. 68:485-495). The utility of these organisms for remediating environmental contamination has been demonstrated in bioaugmentation field studies (Lendvay, et al. (2003) supra; Harkness, et al. (1999) Environ. Sci. Technol. 33:1100-1109; Major, et al. (2002) Environ. Sci. Technol. 36:5106-5116).

It has been shown that Dehalococcoides sp. strain CBDB1, which was originally cultivated on trichlorobenzene (Adrian, et al. (2000) Nature 408:580-583), dehalogenates and can be transferred on selected chlorinated dibenzo-p-dioxins (Bunge et al. (January 2003) Nature 421:357-360). Highly enriched cultures containing strains DF-1 and o-17, bacteria distantly related to Dehalococcoides, dehalogenate chlorinated biphenyls (Wu, et al. (2002) Appl. Environ. Microbiol. 68:807-812; Cutter, et al. (2001) Environ. Microbiol. 3:699-709) and DF-1 also dechlorinates the chlorinated benzenes (Wu, et al. (2002) Environ. Sci. Technol. 36:3290-3294). The genome of D. ethenogenes strain 195 has been sequenced by The Institute for Genomic Research (http://www.tigr.org/tdb/mdb/mdbinprogress.html) and found to contain up to 17 possible dehalogenase genes (Villemur, et al. (2002) Can. J. Microbiol. 48:697-706). Only one dehalogenase, responsible for the dechlorination of TCE, DCE, and VC and encoded by tceA, has been isolated and characterized (Magnuson, et al. (2000) Appl. Envir. Microbiol. 66:5141-5147; Magnuson, et al. (1998) Appl. Environ. Microbiol. 64:1270-1275). The function of the other putative dehalogenase genes is unknown although one of them may be the gene encoding for a PCE dehalogenase (Magnuson, et al. (2000) supra).

U.S. Pat. No. 6,488,850 teaches that pollutant concentrations are reduced by injecting a butane substrate into a contaminated area to stimulate the growth of anaerobic butane-utilizing bacteria which degrade the pollutants. Pollutants specifically taught include tetrachloroethylene (PCE) and carbon tetrachloride (CT).

While several microorganisms have been found which degrade halogenated compounds, the use of these microorganisms has been practically and effectively limited by low concentrations of halogenated pollutants which do not support proliferative growth of the dehalogenating organisms and as a consequence, rates of removal are slow. Needed in the art are microorganisms and methods for enhancing the rate of biotransformation of halogenated pollutants. Particularly useful are methods and microorganisms which are capable of dehalogenating polychlorinated dibenzo-p-dioxins, furans, biphenyls, naphthalenes and the like and bromine-substituted compounds thereof. The present invention meets this long-felt need.

### SUMMARY OF THE INVENTION

The present invention is a method for remediating a material contaminated with a halogenated aromatic compound. The method involves introducing a culture of Dehalococcoides ethenogenes strain 195 into the material contaminated so that the strain removes at least one halogen group from the aromatic compound thereby remediating the material. In one embodiment, the culture is a mixed culture. In another embodiment, a simple halogenated compound is also added into the contaminated material. The method of the present invention is useful in remediation processes carried out in situ or ex situ.

Also provided is a method for enhancing a bioremediation process of a contaminated material. This method is carried out by introducing into a contaminated material, wherein the material contains a dehalogenating organism, an effective amount of a simple halogenated compound. The simple halogenated compound is added to the material to stimulate or support the growth of the organism thereby enhancing the bioremediation process of the contaminated material. In one embodiment of this method of the invention, the dehalogenating organism is Dehalococcoides ethenogenes strain 195. In another embodiment, an electron donor is also added to the material.

A kit for enhancing a bioremediation process of a contaminated material is further provided wherein the kit contains a simple halogenated compound.

### BRIEF DESCRIPTION OF THE DRAWINGS

FIG. 1 shows dechlorination by a butyrate-PCE enriched mixed culture containing D. ethenogenes strain 195 of 1,2,3,4-TeCDD when amended on (Panel A) the serum bottle walls (Panel B) glass beads (Panel C) on sterile sediment and (Panel D) on sterile sediment and autoclaved. Closed squares, 1,2,3,4-TeCDD; Open circles, 1,2,4-TrCDD; Open triangles, 1,3-DCDD. PCE added on day 0. Butyrate added on days 8, 26, 120 and 178. Symbols are averages of triplicate bottles. Error bars represent standard deviations. Where not visible, error bars are smaller than the symbol.

FIG. 2 shows dechlorination by D. ethenogenes strain 195 of sediment applied (Panel A) 1,2,3,4-tetrachlorodibenzo-p-dioxin, Closed squares 1,2,3,4-TeCDD; Open Closed 1,2,4-TrCDD; Open triangles 1,3 DCDD; (Panel B) 1,2,3,4-tetrachlorodibenzofuran, Closed triangles 1,2,3,4-TeCDF; Open diamonds TrCDF; and (Panel C) 2,3,4,5,6-pentachlorobiphenyl, Open squares 2,3,4,5,6-PeCB; Closed Closed 2,4,5,6-TeCB/2,3,5,6-TeCB; Closed diamonds 2,4,6-TrCB. (arrow) PCE added. Symbols are averages of triplicate bottles. Error bars represent standard deviations. Where not visible, error bars are smaller than the symbol.

### DETAILED DESCRIPTION OF THE INVENTION

It has now been demonstrated that D. ethenogenes strain 195 has the ability to dehalogenate many different types of halogen-substituted aromatic compounds, in addition to its known chloroethene respiratory electron acceptors. Thus, methods for remediating materials contaminated with halogenated aromatic compounds via the use of D. ethenogenes strain 195 and other naturally occurring dehalogenating microorganisms are provided herein. During the remediation process, these organisms, through their cellular machinery, collect energy released during the reduction of the halogenated aromatic compounds and use this energy to grow. In particular, it has now been shown that simple halogenated compounds can be amended to contaminated materials to stimulate or support the growth of microorganisms that dehalogenate more complex halogenated aromatic compounds.

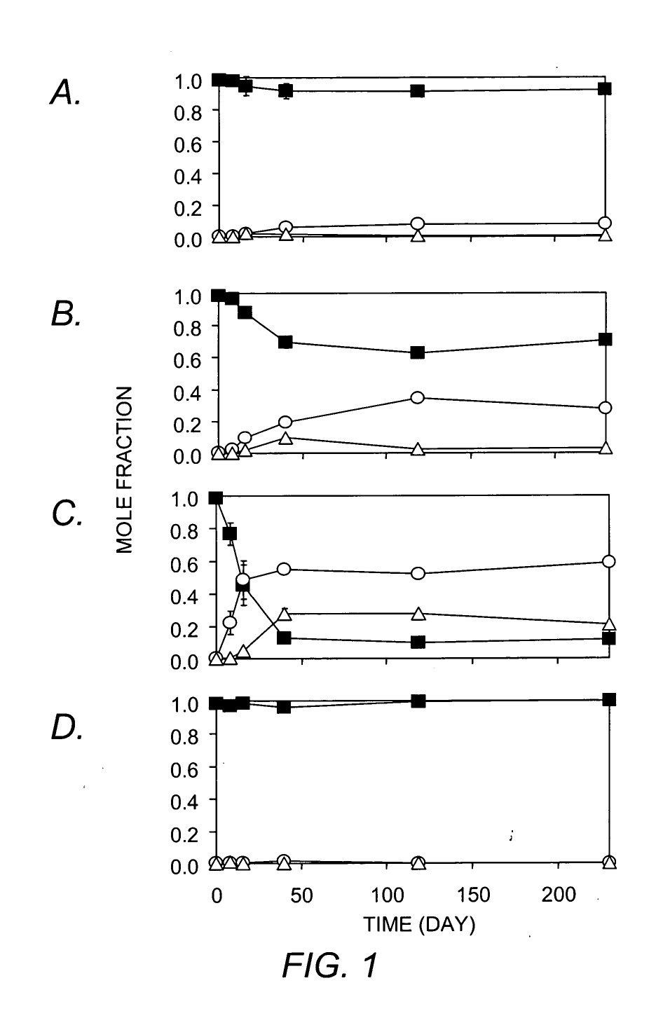

By way of illustration, it was found that a mixed culture containing D. ethenogenes strain 195 (Fennell, et al. (1997) Environ. Sci. Technol. 31:918-926; Fennell, D. E. Ph.D. Dissertation, Cornell University, 1998) could dechlorinate representative polyhalogenated compounds. For example, 1,2,3,4-TeCDD was dehalogenated, but with differing efficiencies depending upon whether the mode of addition of the dioxin was via either a coating on the sides and bottom of the serum bottle (FIG. 1A), sterile glass beads (FIG. 1B) or on dry sterile sediment (FIG. 1C). Dechlorination was less efficient when the compounds were amended onto glass beads or serum bottle surfaces. The most rapid dechlorination was observed when the dioxin was amended to sediment when dechlorination proceeded to a mixture of 1,2,4-trichlorodibenzo-p-dioxin (1,2,4-TrCDD) and 1,3-DCDD within approximately 40 days. Dechlorination then ceased with about 10 percent of the original substrate remaining despite re-amendment of electron donor on day 8, 26, 120 and 178 (FIG. 1C). In the same culture, PCE added on day 0 was dechlorinated to a mixture of VC and ethene within two weeks. No dechlorination was observed in autoclaved controls (FIG. 1D).

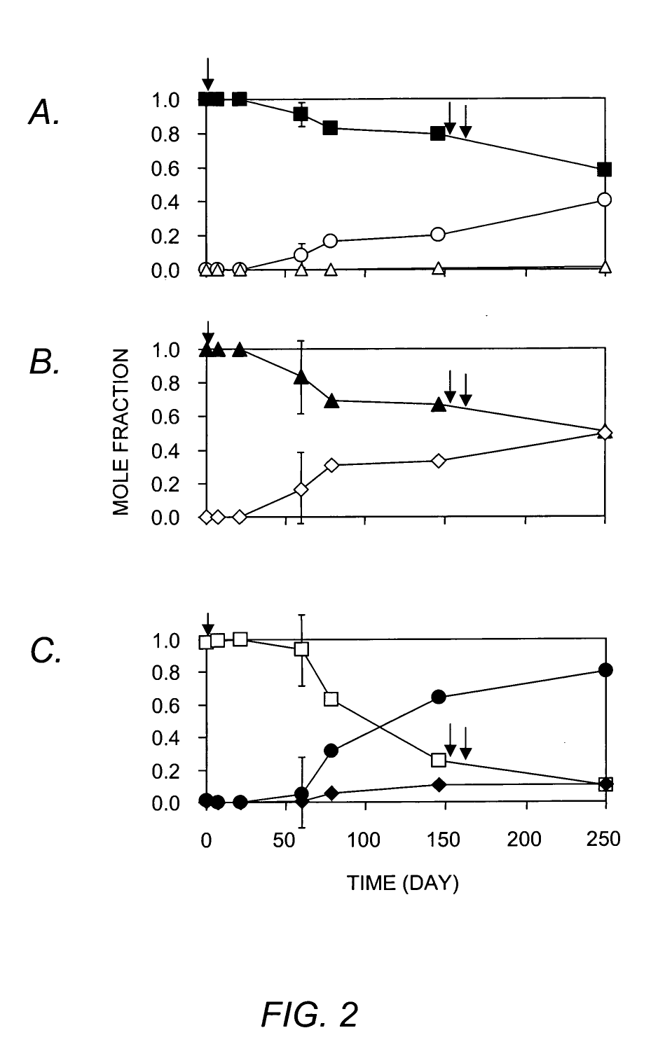

D. ethenogenes strain 195 in pure culture exhibited a lag period prior to onset of dechlorination activity on PCE or chloroaromatics. Thereafter, the pure culture dechlorinated PCE to a mixture of VC and ethene. 1,2,3,4-TeCDD was dechlorinated to primarily 1,2,4-TrCDD, with a trace of 1,3-DCDD (FIG. 2A). 1,2,3,4-TeCDF was dechlorinated to a trichlorinated dibenzo-furan (TrCDF) congener (FIG. 2B). 2,3,4,5,6-PeCB was dechlorinated to 2,3,4,6-TeCB and/or 2,3,5,6-TeCB (these congeners could not be resolved) and 2,4,6-trichlorobiphenyl (2,4,6-TrCB) (FIG. 2C). 1,2,3,4-TeCN was dechlorinated primarily to an unidentified dichloronaphthalene congener (DCN) after 249 days of incubation. A summary of the dechlorination pathways is shown in Scheme 1.

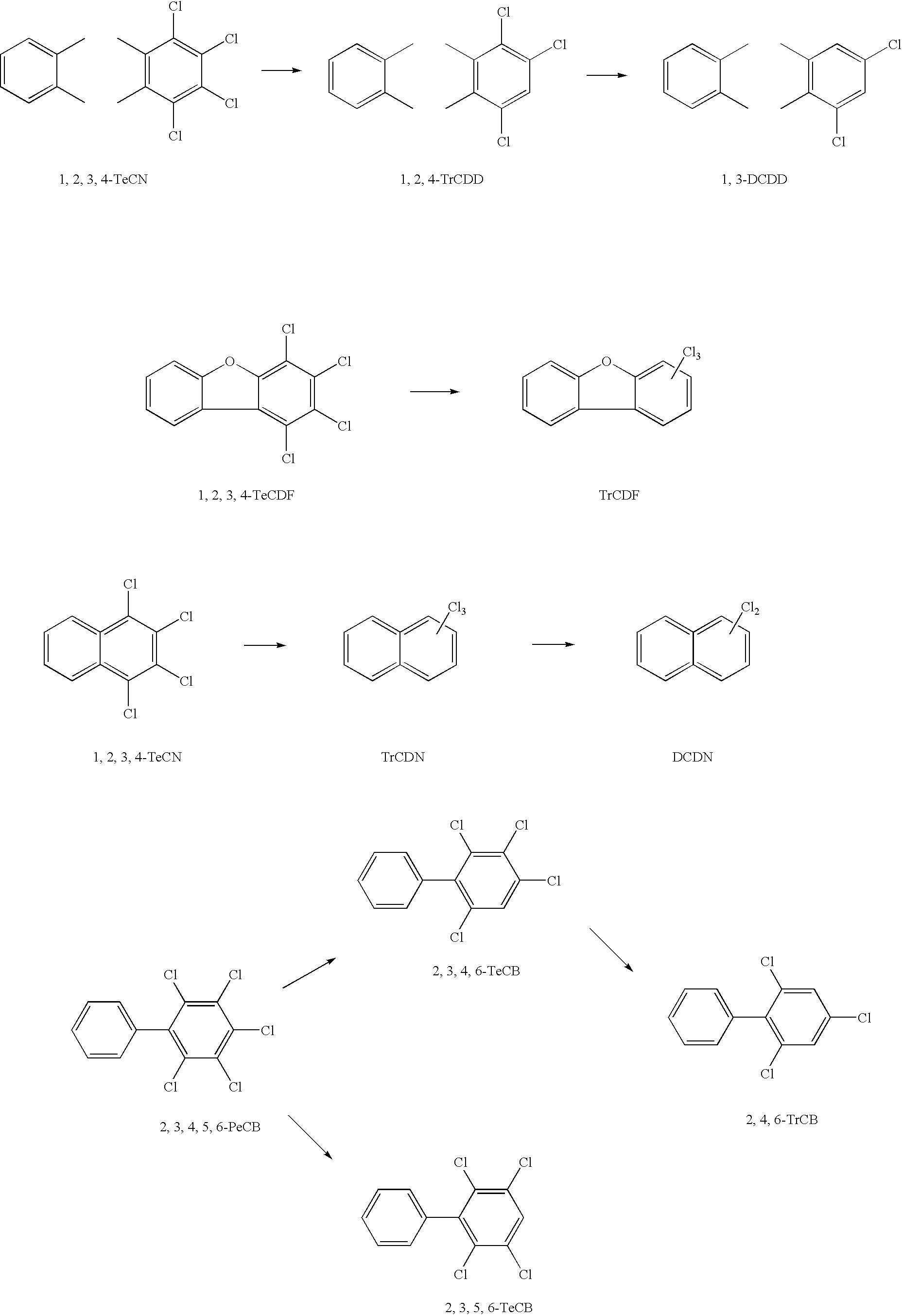

### Scheme 1

The rate of dechlorination of 2, 3, 4, 5, 6-PeCB was more rapid and the extent was greater than that of 1,2,3,4-TeCDD/F dechlorination. Between day 79 and day 149, slower rates of 1,2,3,4-TeCDD and 1,2,3,4-TeCDF dechlorination were observed. PCE was re-amended to the cultures on day 164 and 185, but it was not readily apparent whether this addition resulted in significant concomitant increase in the rate of chloroaromatic dechlorination (FIG. 2). Dechlorination daughter products were not detected from the monochlorophenols, 2,3-DCDD or 2,3,7,8-TeCDD after 249 days. In all cultures, the final two PCE additions were dechlorinated to a mixture of VC and ethene within two weeks, demonstrating that the cultures remained viable and active throughout the incubation period.

The ability of D. ethenogenes to gain energy for growth on chlorinated dibenzo-p-dioxins, dibenzofurans, biphenyls or naphthalenes was not evaluated. However, the ability to transfer dechlorination activity with the chlorobenzenes was investigated. For studies on chlorinated benzenes, D. ethenogenes strain 195 received a first dose of PCE along with the test substrate. This addition provided a substrate in case de novo protein synthesis was required for different dehalogenases and was also used to test for toxic effects on reductive dechlorination by the substrate of interest. PCE was dechlorinated to VC and ethene in all cultures, indicating that none of the tested chlorobenzenes were toxic. HCB, pentachlorobenzene (QCB), and the tetrachlorobenzenes (TeCB) were dechlorinated by strain 195. The molar percentages of the original chlorobenzene and dechlorination products detected in the culture after 150 days are summarized in Table 1.

TABLE 1

| | Original | | | | | | | |
|---|---|---|---|---|---|---|---|---|
| | cloro- | | | | | | | |
| | benzene | Dechlorination products formed (mol %) | | | | | | |
| Original | Remaining | | TeCB | TCB | | DCB | | |
| clorobenzene | (mol %) | QCB | 1,2,3,5 | 1,2,4 | 1,3,5 | 1,2 | 1,3 | 1,4 |
| 1,2,3,4-TeCB | 46 | | | 30 | 3 | 1 | 20 | |
| 1,2,3,5-TeCB | 93 | | | 1 | 6 | | | |
| 1,2,4,5-TeCB | 25 | | | 60 | | | 5 | 10 |
| QCB | 12 | | 10 | 15 | 60 | | 3 | |
| HCB | 46 | 10 | 23 | 1 | 20 | | | |

Cultures were supplied with a starter dose of PCE to provide initial energy for de novo protein synthesis.

Cultures dechlorinating HCB, pentachlorobenzene (QCB) or tetrachlorobenzene (TeCB) (except 1,2,3,5-TeCB) were successfully transferred (5% inoculum) to fresh medium containing the respective chlorobenzene as the sole electron acceptor (with no concurrent PCE addition) and dechlorination activity similar to that of the original culture was observed according to Scheme 2, wherein solid arrows indicate successful transfer with chlorobenzene as sole electron acceptor and dashed arrows indicate observed dechlorination but the process did not occur when this chlorinated benzene was supplied as the sole electron acceptor.

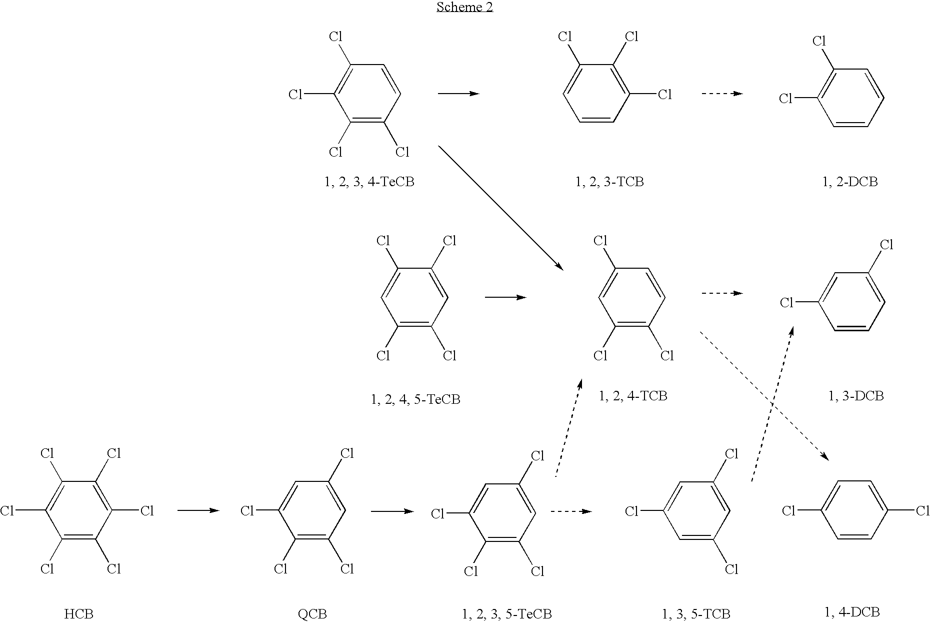

The trichlorobenzenes (TCB) and dichlorobenzenes (DCBs) were not dechlorinated under the conditions tested when they were added as the sole electron acceptor. Benzene was never detected.

The results provided herein are significant given the prevalence of Dehalococcoides-like organisms in the environment and its relatedness to Dehalococcoides sp. strain CBDB1 which was reported to carry out dehalorespiration with selected PCDD congeners (Bunge et al. (January 2003) supra) and PCB dehalogenating strains DF-1 and o-17 (Wu, et al. (2002) supra; Cutter, et al. (2001) supra; Wu, et al. (2002) supra). D. ethenogenes strain 195 and Dehalococcoides sp. strain CBDB1 are close relatives (98% identity over 1422 nucleotides of 16S rRNA gene sequence). Cell extracts of strain CBDB1 were capable of converting HCB and QCB (Holscher, et al. (2003) supra). Furthermore, strain CBDB1 exhibits growth with TeCB, 1,2,3-TCB or 1,2,4-TCB (Adrian, et al. (2000) supra), however, it converts PCE only to trans-1,2-DCE (Adrian, L. Biological Wastewater Treatment: Volume No. 15, Anaerobic Dehalogenation, Colliquium at the Technical University of Berlin, Berlin, Germany, April 2-3, (2001)). Conversely, strain 195 utilized HCB, QCB, 1,2,3,4-TeCB and 1,2,4,5-TeCB, and converts PCE to VC and ethene. In the dechlorination of 1,2,3,4-TeCDD, strain 195 and strain CBDB1 differed in that strain 195 produced 1,2,4-TrCDD and 1,3-DCDD while strain CBDB1 produced 2,3-DCDD and 2-MCDD. Although these strains are closely related and were capable of dechlorinating some of the same substrates, their substrate range did not completely overlap.

D. ethenogenes strain 195 could be transferred and exhibited dechlorination activity with hexa-, penta- and tetra-chlorinated benzene congeners as the sole electron acceptors via the pathways shown in Scheme 2. This is indicative of growth with these compounds. In contrast, a culture grown on VC, a cometabolic substrate (Maymó-Gatell, et al. (2001) Environ. Sci. Technol. 35:516-521), could not be transferred. Culture transferred with VC as sole electron acceptor simply dechlorinated VC at a low rate commensurate with the inoculum size and eventually stopped. This was not the pattern observed for the hexa-, penta- and tetra-chlorinated benzene congeners, where the observed dechlorination was similar to that exhibited by the original culture.

The rate and extent of 2,3,4,5,6-PeCB dechlorination by the pure culture was greater than that of 1,2,3,4-TeCDD/F. Also, the rate and extent of 1,2,3,4-TeCDD dechlorination were less in the pure culture than in the mixed culture. Not wishing to be bound by theory, it is believed that these differences may have been due to the higher incubation temperature (34° C.) of the mixed culture versus the pure culture (28° C.), the slightly higher estimated strain 195 concentration in the mixed culture (16 μg protein/mL) relative to the pure culture (5 to 10 μg protein/mL), the better meeting of the nutritional needs of D. ethenogenes in the mixed culture (Maymó-Gatell, et al. (1997) supra), or the presence of other dehalogenating organisms in the mixed culture. The mixed culture also dehalogenates VC to ethene more efficiently than the pure culture (Maymó-Gatell, et al. (1997) supra; Tandoi, et al. (1994) Env. Sci. Technol. 28:973-979).

Dehalococcoides-containing mixed cultures have been utilized successfully for bioaugmentation of chloroethene contaminated aquifers in small scale field tests (Holliger, et al. supra; Harkness, et al. (1999) supra; Major, et al. (2002) supra). In light of the ability of D. ethenogenes and related organisms to utilize diverse halogenated organic substrates, cultures containing Dehalococcoides spp. or possibly recombinant dehalogenase-containing transgenic organisms developed using genetic elements taken from Dehalococcoides are useful in treating diverse halogenated pollutants. In particular, the ability to grow Dehalococcoides spp. under more favorable conditions in mixed culture on alternate, more bioavailable substrates such as chloroethenes is a significant advantage for producing larger quantities of cells that are useful in bioaugmentation of sites contaminated with poorly available polyhalogenated aromatic compounds such as PCDD/Fs and PCBs.

Accordingly, the present invention is a method for remediating a particulate or liquid material contaminated with a halogenated aromatic compound using a culture of Dehalococcoides ethenogenes strain 195. Particulate materials such as soils and solid waste materials include for instance, gravel, pebbles, stone, stone chips, rock, ore, mining waste, coal, coke, slag, concrete, brick, construction material, demolition material, ash residues such as fly ash and bottom ash, vermiculite, biosolids, aquatic sediment, synthetic resin, or plastic. Liquid materials, include for example, industrial effluents (e.g., scrubber effluents) in pools or holding ponds, contaminated ground water including aquifers, liquid sludge as well as less polluted aqueous run off. Such contaminated particulates, solids and liquids, are hereinafter interchangeably referred to as contaminated material. In particular embodiments of the present invention, the contaminated material is soil or ground water.

As used herein, the term contaminant refers to any matter or material containing an undesirable chemical component or pollutant. A contaminant can be categorized, for instance, as a toxic chemical, carcinogen, organic compound, aromatic compound, dye, a by-product of combustion and of various industrial processes and the like.

Specific chemical contaminants that can be degraded using the methods of the present invention are the halogenated aromatic dioxins, naphthalenes, and dioxin-like compounds including furans and biphenyls or combinations thereof. As used herein, degradation or decontamination is accomplished by removing at least one halogen group from the aromatic compound such that the resulting products of the degradation process are less or substantially less toxic than the original contaminant compound. For example, it is contemplated that removing one chlorine from a trichloro congener can reduce the toxicity by two to three orders of magnitude and further increase the bioavailability of the contaminant so that it can be further degraded. A halogenated aromatic compound encompasses aromatic rings (e.g., benzene, phenol, biphenyl, polycyclic ring structures, or furan) substituted at any position with one or more chloro-, bromo-, fluoro-, or iodo-groups or combinations thereof. It has been shown that bacterium which degrade one halogen-substituted compound will reduce the same compound substituted with another halogen group. For example, denitrifying bacterium strain 3CB-1, degrades 3-chlorobenzoate, 3-bromobenzoate, and 3-iodobenzoate (Haggblom and Young (1999) Arch. Microbiol. 171:230-236). Further, D. ethenogenes strain 195 is known to reductively dechlorinate 1,2-dichloroethane and 1,2-dibromoethane to ETH (Maymó-Gatell, et al. (1997) Science 276:1568-1571). Examples of these halogenated compounds include, but are not be limited to, tetrahalo congeners substituted at positions 1,2,3,4 (e.g., 1,2,3,4-TeCDD); 1,2,3,5; 1,2,4,5 (e.g., 1,2,4,5-tetrabromobenzene); 2,3,4,5; 2,3,5,6; 2,3′,4,4′; 3,3′,4,4′; 3,3′,5,5′; 2,2′,3,3′; 2,2′,4′,5; 2,2′,5,5′; 2,2′,5,6′; 2,2′,6,6′; 3,3′,4,4′ (e.g., 3,3′,4,4′-tetrachlorobiphenyl); or 3,4,4′,5 (e.g, 3,4,4′,5-tetrachlorobiphenyl);
pentahalo congeners substituted at positions 1,2,3,7,8 (e.g., 1,2,3,7,8-PeCDD or 1,2,3,7,8-PeCDF); 2,3,4,5,6; 2,3,4,7,8 (e.g., 2,3,4,7,8-PeCDF); 2,2′,4,5,5′; 3,3′,4,4′,5 (e.g., 3,3′,4,4′,5-pentachlorobiphenyl); 2,3,3′,4,4′; 2,3,4,4′,5; 2,3′, 4,4′,5; or 2,3′,4,4′,5′ pentabromodiphenyl ether;
hexahalo congeners substituted at positions 1,2,3,4,7,8; 1,2,3,6,7,8; 1,2,3,7,8,9; 2,3,4,6,7,8; 2,2′,3,3′,4,4′; 2,2′,3,3′,6,6′; 2,2′,4,4′,5,5′ 2,2′,4,4′,6,6′; 3,3′,4,4′,5,5′; 2,3,3′,4,4′,5; 2,3,3′,4,4′,5′; or 2,3′,4,4′,5,5′;
heptahalo congeners substituted at positions 1,2,3,4,6,7,8 (e.g., 1,2,3,4,6,7,8-HpCDF/hpCDD); 1,2,3,4,7,8,9; or 2,3,3′,4,4′,5,5′; 2,2′,3,3′,4,4′,6;
octahalo congeners (e.g., octachlorodibenzodioxin, octochlorodibenzofuran, octabromodiphenyl ether); or decabromodiphenyl ether.

In particular embodiments, biological transformation of contaminants as disclosed herein is carried out by D. ethenogenes strain 195 either alone or as a mixed culture which contains D. ethenogenes strain 195. A mixed culture can contain D. ethenogenes strain 195 in combination with a single microbial species. Alternatively, a mixed culture contains D. ethenogenes strain 195 in combination with a population of two or more species, which can be of the same or different genera or biotypes within a species. For example, D. ethenogenes strain 195 can be used in combination with other strains of D. ethenogenes or other Dehalococcoides species (e.g., Dehalococcoides sp. strain CBDB1). Under certain circumstances it may be desirable to utilize mixed cultures as a population of various microorganisms can cooperatively degrade multiple contaminants and end-products can be used to maintain cell growth.

When used in mixed culture, D. ethenogenes strain 195 can be grown as a separate culture and subsequently added to the other species or strains of the mixed culture prior to, simultaneously with or subsequent to (e.g., as an adjunct to the aerobic or anaerobic digestion phase of secondary sewage treatment) the introduction of the other microorganisms to the contaminated material. Alternatively, D. ethenogenes strain 195 can be co-cultured with the other species or strains. When co-cultured, the other species or strains of microorganisms should be compatible with D. ethenogenes strain 195 so that strain 195 reaches a suitable percentage of the total microbial population. A suitable percentage of D. ethenogenes strain 195 present in the mixed culture ranges from about 30 to 80 percent on a mass basis (Fennell, D. E. Ph.D. Dissertation, Cornell University, 1998). As D. ethenogenes strain 195 is an obligate anaerobe generally grown under anaerobic conditions, it is desirable that the co-cultured microorganisms also grow under such conditions. As used herein, the term anaerobic is used to describe bacteria which live in the absence or substantial absence of oxygen, including obligate anaerobes, facultative anaerobes and microaerophilic bacteria, wherein facultative anaerobes and microaerophilic bacteria do not require strict anaerobic conditions such as the obligate anaerobes. Whether alone or as a mixed culture, the total population of microorganisms performs the function of biotransforming one or more contaminants.

Microbial organisms which can be used in the mixed cultures with D. ethenogenes strain 195 include, but are not limited to, bacteria, actinomycetes, fungi, and yeast. For example, various facultative and obligate anaerobes including those in the Genera Clostridium, Bacteroides, Peptococcus, Desulfovibrio, Desulfomonile, Peptostreptococcus, Desulfitobacterium, Eubacterium, Lactobacillus and the like can be used to degrade soluble or solubilized organic compounds to form suitable electron donor compounds such as fatty acids (e.g., butyric, propionic, lactic, succinic or acetic acids).

Other bacteria which can be used in mixed culture include acidophilic, alkaliphilic, anaerobe, anoxygenic, autotrophic, chemolithotrophic, chemoorganotroph, chemotroph, halophilic, methanogenic, neutrophilic, phototroph, saprophytic, thermoacidophilic, and thermophilic bacteria. For the degradation of complex organic contaminants in situ, it is desirable to use a various microbial populations (consortia). The consortia degrade contaminant through direct metabolism, sequential metabolism, reductive metabolism, dehalogenation, or cometabolism.

Actinomycetes of the Genera Streptomyces, Nocardia, or Mycobacterium, etc. (see Buchran and Gibbons, Bergey's Manual of Determinative Bacteriology, 8th ed., (1974), Williams and Wilkins Co.) are also contemplated in mixed cultures. Fungi belonging to the Genera Mucor, Rhizopus, Aspergillus, Penicillium, Monascus, or Neurosporium, etc. (see, e.g., J. A. von Ark, “The Genera of Fungi Sporulating in Pure Culture”, in Illustrated Genera of Imperfect Fungi, 3rd ed., V. von J. Cramer, H. L. Barnett, and B. B. Hunter, eds. (1970), Burgess Co.) and yeasts belonging to the Genera Saccharomyces, Zygosaccharomyces, Pichia, Hansenula, Candida, Torulopsis, Rhodotorula, Kloechera, etc. (see J. Lodder, The Yeasts: A Taxonomic Study, 2nd ed., (1970), North-Holland) can also be used in mixed cultures. Microorganisms for use in the method of the present invention can be naturally occurring organisms which have been selected for the ability to degrade particular halogenated compounds or they can be genetically engineered to degrade selected halogenated compounds (e.g., transformed with genes encoding one or more dehalogenases). It is to be understood that the foregoing listing of microorganisms is meant to be merely representative of the types of microorganisms that can be used in mixed cultures according to the present invention.

Growth of microorganisms prior to being introduced to a contaminated sample can be carried out using standard culturing media, conditions (e.g., temperature), and methods well-known to those of skill in the art and may vary with the species and strains being grown.

The method of the present invention involves decontaminating or remediating a contaminated material by providing to the material D. ethenogenes strain 195 or a mixed culture containing D. ethenogenes strain 195 and allowing the microorganisms to degrade the contaminants in situ or ex situ.

Non-indigenous microorganisms can be delivered to the surface or subsurface of contaminated material by any one of the many well-known methods. For example, contaminated material can be inoculated via irrigation lines (see, e.g., Newcombe and Crowley (1999) Appl. Microbiol. Biotechnol. 51(6):877-82), via activated soil (see, e.g., Barbeau, et al. (1997) Appl. Microbiol. Biotechnol. 48(6):745-52) or as a dilute or concentrated liquid. Alternatively, ex situ bioreactors can be used as described in U.S. Pat. No. 5,888,396. In general, remediation of contaminated material can be carried out at temperatures in the range of 28-38° C. to maintain a diverse community of microorganisms at densities of 10⁷ to 10¹⁰ cells per mL. As will be appreciated by those of skill in the art, cell densities and reaction times can vary with the prevailing conditions, such as temperature, contaminant composition and contaminant concentrations.

In particular embodiments of the present invention, the remediation process carried out by a dehalogenating organism can be enhanced by adding or introducing into the contaminated material a simple aliphatic halogenated compound. As a simple halogenated compound is more readily degraded, it can be used to stimulate or support the growth of naturally occurring dehalogenating organisms already present in the contaminated material. Alternatively, the simple halogenated compound can be added prior to, simultaneously with or subsequent (e.g., immediately, one week, one month, or one year or more) to the introduction of non-indigenous microorganisms to the contaminated material. Repeated reamendment of the simple halogenated compound during the bioremediation process is also contemplated. As a further alternative, or in addition to, microorganisms can be grown in the presence of the simple halogenated compound prior to being introduced into the contaminated material to establish, stimulate, or support the growth of a suitable population of microorganisms that can degrade the desired contaminants. Advantageously, the simple halogenated compounds support the growth of the microorganisms and are themselves transformed into harmless end-products. For example, dehalogenating bacteria such as Dehalococcoides, can proliferate on tetrachloroethene and simultaneously degrade said halogenated compound to ethene.

As used herein, a simple halogenated compound can include any C1, C2, C3 or C4 hydrocarbon substituted with a chloro-, bromo-, fluoro-, or iodo-group. Exemplary C1 simple halogenated compounds include, but are not limited to, iodomethane, dichloromethane, dibromomethane, diiodomethane, bromochloromethane, tribromomethane, trichloromethane, or tetrachloromethane. A C2 simple halogenated compound which can be used to stimulate the growth of an microorganism used in accordance with the method of the present invention includes, but are not limited to, bromoethane, iodoethane, 1,1-dichloroethane, 1,2-dichloroethane, 1,1,2-trichloroethane, pentachloroethane, 1,1,2-trichlorotrifluoroethane, hexachloroethane, dichloroethene, trichloroethene, tetrachloroethene, or tetrafluoroethene. Suitable C3 simple halogenated compounds include, but are not limited to, 1-chloropropane, 2-chloropropane, 1-bromopropane, 2-iodopropane, 1,3-dichloropropane, 1,2-dibromopropane, 1,3-dibromopropane, 3-chloropropene, or 3-bromopropene. Exemplary C4 simple halogenated compounds include, but are not limited to, 1-chlorobutane, 1-bromobutane, 1-bromo-2-methylpropane, 1,1-dichlorobutane, 4-bromo-1-butene, or hexachloro-1,3-butadiene. In particular embodiments, a simple halogenated compound is a tetra-, tri- or dichloroethene.

An effective amount of a simple halogenated compound is an amount which establishes, stimulates, or supports the growth of dense populations (e.g., 10⁷ to 10¹⁰ cells per mL) of microorganisms. Useful concentrations of the simple halogenated compound in the contaminated material range from about 50 μM to 500 μM or from about 100 μM to 300 μM or at about 150 μM.

As a further embodiment of the present invention, a contaminated material can be further amended with a suitable electron donor such as a fatty acid (e.g., butyric, propionic acid, or lactic acid), short-chain alcohol or any fermentable substance that upon fermentation produces hydrogen and acetate. Other suitable electron donors are disclosed in U.S. patent application Ser. No. 09/895,430. Electron donors can be supplied at a final concentration ranging from about 100 μM to 5 mM depending on the electron donor. Alternatively, the electron donor can be generated by microorganisms which produce the same. Suitable microorganisms are disclosed herein.

The invention also provides a kit for treatment of a contaminated material. In general, the kit includes a simple halogenated compound. The kit may further contain a pure or mixed culture of microorganisms having the property of solubilizing or biodegrading a halogenated compound contaminant. In one embodiment, the culture contains D. ethenogenes strain 195. In another embodiment, the kit contains an electron donor.

The invention is described in greater detail by the following non-limiting examples.

### EXAMPLE 1

### Chemicals and Stock Solutions

1,2,3,4-Tetrachlorodibenzo-p-dioxin (1,2,3,4-TeCDD); 1,2,3-trichlorodibenzo-p-dioxin (1,2,3-TrCDD); 1,2,4-TrCDD; 2,3-dichlorodibenzo-p-dioxin (2,3-DCDD); 1,2-DCDD; 1,3-DCDD; 1,4-DCDD; 1-monochlorodibenzo-p-dioxin (1-MCDD); 2-MCDD; dibenzo-p-dioxin; 2,3,4,5,6-pentachlorobiphenyl (2,3,4,5,6-PeCB); 1,2,3,4-tetrachloronaphthalene (1,2,3,4-TeCN); octachloronaphthalene and 2,2′,5-trichlorobiphenyl were obtained from AccuStandard (New Haven, Conn.). 1,2,3,4-Tetrachlorodibenzofuran (1,2,3,4-TeCDF); 1,2,4-trichlorodibenzofuran (1,2,4-TrCDF); 1,3-dichlorodibenzofuran (1,3-DCDF); 2-monochlorodibenzofuran (2-MCDF); dibenzofuran; all possible tetra- and tri-chlorinated biphenyl congeners; 1,4-dichloronaphthalene (1,4-DCN); 2,3-DCN; 2-chloronaphthalene and 1-chloronaphthalene were obtained from Ultra Scientific (North Kingstown, R.I.). All naphthalene and dibenzofuran congeners that were potential dechlorination daughter products were not commercially available, and the chlorine substituent positions of the products of chloronaphthalene and chlorodibenzofuran dechlorination were not determined. PCE, VC; 2-chlorophenol (2CP); 3-chlorophenol (3CP); 4-chlorophenol (4CP) and the chlorinated benzenes were obtained at the highest purity available from Sigma-Aldrich (St. Louis, Mo.). Ethene (99%) was obtained from Matheson Gas Products (Montgomeryville, Pa.).

### EXAMPLE 2

### Culture Preparation

A mixed culture containing D. ethenogenes strain 195 was grown at 34° C. according to standard methods (Magnuson, et al. (1998) supra; Fennell, et al. (1997) supra) on PCE and butyric acid. It has been reported that D. ethenogenes strain 195 produces 4.8 grams of protein per mol chloride released (for PCE, TCE and DCE) (Maymó-Gatell, et al. (1997) supra). The mixed culture contained, through stoichiometric estimation based upon this yield value, a solids retention time of 40 days and an influent PCE concentration of 1100 PM, approximately 16 μg D. ethenogenes protein/mL (Fennell, et al. (1997) supra). Pure culture D. ethenogenes strain 195 was grown at 34° C. according the well-established methods (Maymó-Gatell, et al. (1997) supra; Maymó-Gatell, et al. (1995) Appl. Environ. Microbiol. 61:3928-3933; Maymó-Gatell, et al. (1999) Appl. Environ. Microbiol. 65:3108-3113). The culture was used after dechlorination of approximately 500 μmol/L PCE which corresponds to approximately 2-4×10⁸ cells per mL or 5-10 μg protein per mL, estimated by use of a standard growth curve (Maymó-Gatell, et al. (1997) supra).

### EXAMPLE 3

### Dehalogenation Tests

The mixed culture was used to assess the best mode of delivery of 1,2,3,4-TeCDD; 2,3,7,8-TeCDD; 2,3-DCDD; 1,2,3,4-TeCDF; 2,3,4,5,6-PeCB; 1,2,3,4-TeCN to the cultures. To triplicate bottles of mixed culture was added 0.78 mmol of 1,2,3,4-TeCDD via a coating on dry, sterile sediment (Vargas, et al. (2001) Appl. Microbiol. Biotechnol. 57:786-790) or by coating on 1.5 mm borosilicate glass beads or the sides and bottom of the serum bottle itself. No other amendment techniques were used. The culture tolerated the dioxin-coated sediment and this mode of delivery yielded the highest dehalogenation activity compared to the other addition methods. In a separate experiment, addition of dry sterile sediment did not interfere with PCE dechlorination by the pure culture. Therefore, the pure culture was amended with the halogenated compounds via the sediment method (Vargas, et al. (2001) supra). Briefly, dry, sterile sediment, 0.25 grams, was added to a 50 mL serum vial. The vials were sealed with a TEFLON-coated gray butyl rubber stopper, crimped with an aluminum crimp cap and autoclaved. Stock solution containing each respective substrate (Table 2) was added to triplicate bottles via a sterile glass syringe. The stock solution was allowed to coat the sediment. The solvent was evaporated overnight under sterile, anoxic nitrogen. After the sediment was dry, the bottle was purged an additional 30 minutes with 70% nitrogen/30% carbon dioxide. Bottles for live controls and bottles receiving chlorophenols contained dry sterile sediment which had been wetted with toluene alone and then evaporated.

Chlorophenols were added from 0.1 N NaOH solutions via a sterile anoxic syringe. Killed controls amended with 1,2,3,4-TeCDD and PCE were prepared by autoclaving for 30 minutes.

TABLE 2

| | MW | Stock | | μmol/ | μmol/L | μg/g |
|---|---|---|---|---|---|---|
| Substrate | (g/mol) | Solvent | mg/bottle | bottle | culture† | sediment‡ |
| PCE | 165.8 | Neat | 0.5 to | 2.8 to | 110 to 350 | na |
| | | (toluene)* | 1.5 | 8.8 | | |
| Chlorobenzenes | varied | Pentane/ | varied by | 20 | 2000 | na |
| | | hexadecane | congener | | | |
| 1,2,3,4-TeCDD | 322 | toluene | 0.25 | 0.78 | 31 | 1000 |
| 2,3,7,8-TeCDD | 322 | toluene | 0.01 | 0.03 | 1.2 | 40 |
| 1,2,3,4-TeCDF | 305.98 | toluene | 0.1 | 0.33 | 13 | 400 |
| 2,3,4,5,6-PeCB | 326.4 | toluene | 0.25 | 0.77 | 31 | 1000 |
| 1,2,3,4 TeCN | 265.95 | toluene | 0.2 | 0.75 | 30 | 800 |
| 2,3-DCDD | 252 | isooctane | 0.008 | 0.03 | 1.2 | 30 |
| 2-,3-,4- | 128.56 | 0.1 N NaOH | 0.64 | 5 | 200 (each) | na |
| Chlorophenol | | | (each) | (each) | | |

Na = not applicable.
*toluene was added to dried sediments then evaporated (as for other bottles sets) during the set up of PCE-only controls.
†nominal aqueous-phase concentration neglecting partitioning.
‡assuming 100% partitioning to the sediment.

To test for dechlorination of 1,2,3,4-TeCDD and to compare modes of dioxin delivery, 25 mL mixed culture was added to the serum bottles using a sterile glass syringe. Butyric acid (440 μM) and pre-fermented yeast extract (4 μL of a 50 g/L solution) were added as electron donor and nutrient source, respectively (Fennell, D. E. Ph.D. Dissertation, Cornell University, 1998; Maymó-Gatell, et al. (1995) supra). PCE (110 μM) was added at time zero to ensure a successful establishment of the cultures. Butyric acid and pre-fermented yeast extract were added at time zero and on day 8, 26, 120 and 178. Mixed cultures were agitated inverted at 200 rpm at 34° C.

D. ethenogenes pure culture (25 mL) was added to triplicate 50-mL serum bottles, prepared via the sediment method as described herein and in Table 2, using a sterile glass syringe to test the dehalogenation of 1,2,3,4-TeCDD; 2,3,7,8-TeCDD; 2,3-DCDD; 1,2,3,4-TeCDF; 2,3,4,5,6-PeCB; 1,2,3,4-TeCN and the chlorophenols. Chlorophenols were added from a 0.1 N NaOH solution (Table 2). PCE (350 μM) was added initially and the bottles were pressurized to 5 PSI with pure hydrogen gas. The pure cultures were incubated inverted at 28° C. at 100 rpm. PCE dechlorination in the pure culture exhibited a lag period of approximately two months. This lag may have been caused by residual toluene (40±40 μM) from the delivery of the stock solutions. On day 21, bottle headspaces were purged with 70% nitrogen/30% carbon dioxide for 0.5 hour, reducing the toluene residual by approximately half (19±19 μM) with the highest concentration at 60 μM. After purging, PCE was dehalogenated to a mixture of VC and ethene within five weeks. PCE (175 μM) was added again on day 164 and day 185 and was dechlorinated to VC and ethene within two weeks.

For the chlorobenzene studies, cultures of D. ethenogenes strain 195 were inoculated into triplicate 27 mL Balch tubes containing 10 mL of growth medium (Maymó-Gatell, et al. (1999) supra). The cultures received a 2.5% vol/vol inoculum of D. ethenogenes strain 195 culture grown with PCE as the substrate. At the time of inoculation, a dose of PCE (300 μM) was added with 2 mM (nominal aqueous phase concentration, neglecting partitioning to other phases) of one of the chlorinated benzenes. The tested chlorobenzenes, except for hexachlorobenzene (HCB), were added using the “two-phase liquid system” (Holliger, et al. (1992) Appl. Environ. Microbiol. 58:1636-1644) as a solution in hexadecane (0.1 mL of hexadecane per tube). Because HCB did not dissolve well in hexadecane, it was instead added in pentane to empty sterile Balch tubes, the pentane was then evaporated with a stream of sterile nitrogen gas and fresh medium with the appropriate amendments and 0.1 mL hexadecane was added. Transfers of 5% inoculum were used to demonstrate the use of the chlorobenzene congeners as sole electron acceptors.

### EXAMPLE 4

### Analytical Methods

Chloroethenes and toluene were determined from headspace samples analyzed with a Hewlett-Packard 5890 series II gas chromatograph with flame ionization detection (GC-FID). Compounds were separated on a 30-m SPB-Octyl (1.0-μm film thickness) capillary column with a 0.32-mm inner diameter. PCE and its dechlorination products were determined using a Perkin Elmer Autosystem XL gas chromatograph equipped with a 3 meter 60/80 CARBOPACK B/1% SP™-1000 column and FID. The column was kept isothermally at 210° C. with N₂ as carrier gas.

For a rapid, qualitative check for benzene through trichlorobenzene dechlorination products, the Cornell equipment was used but the 60/80 CARBOPACK B/1% SP™-1000 column length was about 1 meter. The oven was run with a time program: 5 minutes at 200° C., increase 12.5° C./minute to 225° C., 225° C. for 23 minutes. Well-established methods were used for quantitative analysis of benzene through HCB (Stan and Kirsch (1995) Intern. J. Environ. Chem. 60:33-40). Samples of 0.5 mL culture liquid, thoroughly mixed to include a representative portion of hexadecane, were extracted with n-hexane and 2,4-dichlorotoluene was added as the internal standard. The Perkin Elmer Autosystem XL gas chromatograph was equipped with a 60 m, 0.53 mm ID, 1.5μ RTX®-35 (CROSSBOND® 35% diphenyl/65% dimethyl polysiloxane) capillary column and FID. Helium was the carrier gas at 15 mL/minute; the oven was run with a time program: 2 minutes at 40° C., increase 8° C./minute to 120° C., 120° C. for 0.5 minutes; increase 10° C./minute to 230° C., 230° C. for 10 minutes. Output data was analyzed with Turbochrom Navigator software version 4.1 from Perkin Elmer Nelson (San Jose, Calif.). The chlorobenzenes were quantified using 2,4-dichlorotoluene as the internal standard. Standard response curves for each compound were prepared in tubes using the same volumes of aqueous, gas and hexadecane phases as the culture tubes and utilizing the same sampling and extraction protocol. These standards corrected for partitioning of the chlorobenzenes into the gas phase. Dechlorination daughter product distribution was expressed as a molar percentage of the total chlorobenzenes (moles of original compound remaining plus moles of dechlorination products formed) present in the culture tube after 150 days of incubation.

PCDD/Fs (Vargas, et al. (2001) supra) and PCBs (Alder, et al. (1993) Environ. Sci. Technol. 27:530-538) were analyzed by gas chromatography-mass spectrometry in accordance with standard methods. PCNs were analyzed using the PCB method (Alder, et al. (1993) supra). Briefly, the bottles were shaken thoroughly and 1 mL of culture medium-sediment slurry was withdrawn with a sterile syringe flushed with oxygen-free N₂. Samples were separated into an aqueous and solid phase by centrifugation. Water was removed from the solid phase by an acetone rinse. 2,2′,5-trichlorobiphenyl was added as an internal standard for PCDD/F analyses and octachloronaphthalene (OCN) was added as an internal standard for PCB and PCN analyses. For PCDD/F analyses, the solid phase was extracted with toluene:acetone (1:1 v/v) overnight and then again for 4 hours. The toluene/acetone extracts were pooled with the aqueous phase. For PCB and PCN analyses, the solid phase was extracted with hexane:acetone (1:1 v/v) overnight and then again for 4 hours. The hexane/acetone extracts were pooled with the aqueous phase. Acetone was removed by reverse partition into water and the toluene or hexane extract was concentrated. Sample clean-up to remove interfering organic compounds was performed using a FLORISIL® (SIGMA-Aldrich, St. Louis, Mo.) column. Samples were analyzed by gas chromatography mass spectrometry (GC-MS) on a Hewlett Packard 5890 gas chromatograph with a HP 5971 mass-selective detector, using a DB-5MS fused silica column (30 m, 0.25 mm i.d., film thickness 0.2 μm, J&W Scientific, Folsom, Calif.). PCBs and PCDDs were identified based on retention times of standards and selective ion monitoring (m/z: TeCDD 322, TrCDD 286, DCDD 252, MCDD 218, PeCB 326, tetrachlorobiphenyl 292, trichlorobiphenyl 256, dichlorobiphenyl 222, OCN 404). Resolution of the 2,4,5,6- and 2,3,5,6-tetrachlorobiphenyl (2,3,4,6-TeCB/2,3,5,6-TeCB) isomers using the method disclosed herein was not successful.

The 1,2,3,4-TeCDF and 1,2,3,4-TeCN dechlorination products were identified by the number of chlorine substituents, not chlorine position, since not all potential dechlorination products were available commercially. Dechlorination products were detected based upon selective ion monitoring of expected major ions for tetra-, tri- or dichlorinated congeners (m/z: TeCDF 304, TrCDF 270, DCDF 236, OCN 404, TeCN 266, trichloronaphthalene 231, dichloronaphthalene 196).

The extraction efficiency for 1,2,3,4-TeCDD (at 2 μM) was above 85% (Vargas, et al. (2001) supra). The detection limit for the different compounds was approximately 0.01 mmol/L.

Results for the chlorinated aromatic compounds are presented by expressing each compound as a mole fraction of the total concentration of the congers detected at each sampling point. Total PCDD/F, PCB, or PCN recovered at each sampling event varied because of the difficulty in sampling the aqueous/sediment slurry in a representative manner and because of the differing aqueous solubilities of the parent and dechlorination daughter compounds. The method of data presentation assumes no anaerobic degradation of the dibenzo-p-dioxin, dibenzofuran, biphenyl, or naphthalene molecule (if produced) and that the chlorinated compounds underwent no significant reactions other than dechlorination.

Chlorophenols were analyzed using HPLC (Alder, et al. (1993) supra)

1. A method for remediating a material contaminated with a halogenated aromatic compound comprising introducing a culture of Dehalococcoides ethenogenes strain 195 into a material contaminated with a halogenated aromatic compound so that said strain removes at least one halogen group from the aromatic compound thereby remediating the material.

2. The method of claim 1, wherein the culture comprises a mixed culture.

3. The method of claim 1, wherein the remediation is carried out in situ or ex situ.

4. The method of claim 1, further comprising adding a simple halogenated compound into the contaminated material.

5. A method for enhancing a bioremediation process of a contaminated material comprising introducing into a contaminated material, wherein said material contains a dehalogenating organism, an effective amount of a simple halogenated compound so that the growth of the organism is stimulated or supported thereby enhancing the bioremediation process of the contaminated material.

6. The method of claim 5, wherein the dehalogenating organism is Dehalococcoides ethenogenes strain 195.

7. The method of claim 5, further comprising adding an electron donor.

8. A kit for enhancing a bioremediation process of a contaminated material comprising a simple halogenated compound.
